(19) United States
(12) Patent Application Publication
(10) Pub. No.: US 2022/0373993 A1
(43) Pub. Date: Nov. 24, 2022

(54) Three-Dimensional Printing with Surface Dithering

(71) Applicant: Fraunhofer Gesellschaft zur Förderung der angewandten Forschung e.V., München (DE)

(72) Inventors: Alan Brunton, Grenoble (FR); Philipp Urban, Seeheim (DE); Mostafa Morsy, Darmstadt (DE)

(21) Appl. No.: 17/749,075

(22) Filed: May 19, 2022

(30) Foreign Application Priority Data
May 20, 2021 (EP) 21175084.9

(51) Int. Cl. G05B 19/4099; B33Y 50/00; B29C 64/386

(52) U.S. Cl. CPC G05B 19/4099; B33Y 50/00; B29C 64/386; G05B 2219/49023

(57) ABSTRACT

A method for three-dimensional printing includes dithering a set surface of the printing object and printing the printing object with the dithered surface. The dithering includes determining the set surface of the printing object, providing a spatially high-frequent dithering signal, and modifying the set surface as a function of the dithering signal. A non-transitory computer-readable medium includes instructions that implement the method. A 3D printing device includes a printing device and a control unit configured to control the printing device using the method.

### CROSS-REFERENCE TO RELATED APPLICATIONS

This application claims priority to EP 21175084.9 filed May 20, 2021, the entire disclosure of which is incorporated by reference.

### FIELD

The present disclosure relates to a method for three-dimensional printing, a computer program product for three-dimensional printing, and a 3D printing device.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In 3D printing, it is desirable to reproduce an appearance of an object model as far as possible. Besides a color reproduction and/or a translucency reproduction, it is also desired to reproduce the shape of the model as far as possible.

With respect to the reproduction quality, two phenomenon can be observed.

First, the voxel resolution of binary 3D printers (such as material jetting printers) defines the upper limit of geometric accuracy since just the whole volume of the voxel can be filled with build material or left empty. Resulting quantization errors between the input surface and the voxel surface may (and mostly) include edges, i.e., the quantization signal on the surface contains directional high-frequency components. Since most 3D printing systems employ anisotropic voxels, the magnitude of quantization errors depends on the surface orientation.

The directional, surface-orientation-dependent quantization errors yield staircasing artifacts in the final 3D printing object. These artifacts can be visually disturbing when viewed at close range in particular for small objects due to the low signal-to-noise-ratio. But also for larger objects viewed from a bigger distance they can create unwanted specular highlights at surfaces viewed under off-specular conditions.

In addition to visual effects, staircasing artifacts adversely affect the fatigue behavior of an object. This is because staircases or small cracks of the surface can be seeds for ruptures.

Second, a voxel representation is just an idealistic model of material placement. In addition to droplet-positioning noise and pre-cured material mixing in the case of printing by material jetting, it is possible that dots are placed in interlaced patterns with considerable overlap between voxels resulting in material cross-contamination between neighboring voxels. This can be desired or even necessary to ensure structural integrity of the print. Furthermore, the correct height along a vertical axis can be enforced by leveling mechanisms via a roller or a squeegee, which may squeeze excess material into neighboring voxels. The result is a thickened print in directions perpendicular to the vertical axis. Furthermore, build and support material may mix at vertical surfaces before curing so that not all support material can be removed in the cleaning process, which further contributes to the thickening effect.

It is known that, in order to obtain pleasant surfaces, staircase artifacts are removed mechanically in a costly post-process by sanding or polishing.

The U.S. Pat. No. 7,658,976 B2 discloses apparatuses and methods useful in three-dimensional object printing. It is proposed to slice in double resolution for the dimension where the printer resolution is the lowest and use an interlacing approach to reduce the output back to the printer resolution. This is a directional geometric dither that is, however, limited to distinct surface orientations. Furthermore, it is computationally expensive since the number of addressed voxels doubles.

In order to correct the thickening, different approaches are applied which comprise

a. Mechanically by sanding or polishing.

b. the input 3D model my making the parts thinner so that after the process-based thickening the part has the desired thickness.

c. Eroding each slice by morphological operators.

US 2018/0281291 A1 discloses a 3D object forming device and a 3D object forming method, in particular to a halftone processing on the formation data using a dithering method.

U.S. Pat. No. 7,658,976 B2 discloses apparatuses and methods useful in three-dimensional object printing.

### SUMMARY

There is the technical problem of providing a method for three-dimensional printing, a computer program product and a 3D printing device which enable an improved reproduction of an object to be printed, in particular an improved reproduction with improved durability.

The solution to the technical problem is provided by the subject-matter with the features of the independent claims. Advantageous embodiments are provided by the subject-matter with the features of the remaining sub claims.

A method for three-dimensional printing is proposed. The method comprises the steps of

dithering a surface of the printing object (dithering step),

printing the printing object with the dithered surface (printing step).

The printing process can comprise the generation of successive slices, i.e. layers, which are oriented perpendicular to a vertical axis (z-axis). Such a slice can also be referred to as z-slice. The z-slices can be oriented parallel to a plane spanned by a longitudinal axis (x-axis) and lateral axis (y-axis). Such a slice can also be referred to as x, y-slice. The mentioned axes can provide axes of a reference coordinate system, in particular of a printing space or build space coordinate system. A z-slice therefore denotes a two-dimensional cross section of the printing object, e.g. with predetermined thickness, wherein the section plane is perpendicular to the aforementioned vertical direction.

Before performing the dithering step, e.g. in a modelling step, a model of the 3D printing object can be created, e.g. by computer added design (CAD). The modelling step can be part of the claimed method. Such a model can also be generated by 3D-scanning, in particular by capturing shape, color and translucency information of an object which is to reproduced by printing.

The model can encode reproduction information, wherein a reproduction information can denote or comprise a shape information, color information and/or translucency information. These pieces of information provide a specification of what shape, color and/or translucency perception from the printing object a user wishes to have. In other words, the information encodes set values for the shape, color and/or translucency of the printing object.

The modelling step can be performed independent of the 3D printing device which is to be used.

By the modelling step, input data for the proposed method can be generated. The input data can encode shape information as texture information or vertex information. Further, color and translucency information can be encoded by a RGBA signal on the object's surface, for example in form of a RGBA texture or per-vertex RGBA attributes. An RGBA signal can e.g. be provided by a RGBA vector, wherein entries of the “RGB” portion encode a color information and the entry of the “A” portion encodes a translucency information. Thus, a desired color and translucency can be assigned to the printing object or parts thereof. The input data can be generated independent of a 3D printing device. Examples for a possible data format of input data is the so-called .obj data format, the .wrl data format or the 0.3 mf data format whereas the color and translucency is embedded in such formats as a RGBA texture file encoded e.g. in a PNG data format or a TIFF data format. For example, the 0.3 mf data format is created to store textured 3D models for 3D printing by an industrial consortium.

Preferably, the reproduction information can be provided by a texture image, wherein every point or selected points on a 3D surface representation of the printing object has assigned coordinates in the domain of a texture image. Based on the input data, control data for a 3D printing device can be generated, wherein the control data is used to control the printing process. Control data can e.g. be generated based on data generated in the dithering step and/or in the erosion step which will be explained later.

The 3D printing process can e.g. be an extrusion-based process, a wire-based process, a granular-based process, a power-bed process or a lamination-based process. Preferably, the 3D printing process comprises a material jetting process with a subsequent polymerization. In such processes, one or more liquid printing materials, e.g. liquid photo polymers, are applied into or onto a layer and exposed to radiation, e.g. to a laser beam, in order to harden to exposed printing material. For example, printing materials can be provided by printing inks, wherein the printing inks can be hardened or cured after the application on to or into a layer, e.g. by exposure to light, in particular to UV radiation. The printing inks can have different colors and/or degrees of translucency. The process can also be referred to as polyjetting which is also known as multi jet modelling.

According to the invention, the dithering step comprises

determining the set surface of the printing object,

providing a spatially high-frequent dithering signal,

modifying the set surface as a function of the dithering signal.

The set surface can be determined in a reference coordinate system, in particular in a voxel grid coordinate system and/or a build space coordinate system. The set surface can denote a course or shape of the set surface. The printing object can denote the object to be printed according to the proposed method.

The spatially high-frequent signal can denote a spatially varying signal, wherein a DC or steady component is zero or not higher than a predetermined threshold value. The spatially high-frequent signal can also denote a spatially varying signal, wherein a spectral density of a low frequency portion is smaller than a spectral density of a high frequency portion. The low frequency portion comprises frequencies ranging from 0 to a threshold frequency (inclusive). The high frequency portion comprises frequencies ranging from the threshold frequency (exclusive). The threshold frequency can be determined as a predetermined fraction of a predetermined maximum spatial frequency, e.g. as 10%, 20%, 50%, 70% fraction. The maximum spatial frequency can be a printer-specific frequency and can in particular depend on the voxel resolution of the printer or the voxel size which can be achieved with the printer. In particular, the maximum spatial frequency can be the inverse of the smallest voxel dimension.

The dithering signal can be a multidimensional signal, e.g. defined in relation to the reference coordinate system. In this case, the dithering signal can be defined such that a signal course along each spatial direction within the reference coordinate system is a spatially high-frequent signal. Preferably, the dithering signal is provided by a three-dimensional matrix, wherein values of the elements of the matrix provide signal values of the dithering signal. Values of elements can e.g. be in the range from 0 (inclusive) to 1 (inclusive) or from −0.5 (inclusive) to 0.5 (inclusive). In this case, the signal values of the elements along each signal path, i.e. a signal path with an arbitrary orientation, through the matrix will provide a spatially high-frequent signal.

The dithering signal can in particular be a blue noise signal or can be determined as a function of a blue noise signal. A blue noise signal or characteristics of a blue noise signal are e.g. defined in Daniel L. Lau and Gonzalo R. Arce, Modern Digital Halftoning, Second Edition, 2008, Taylor & Francis Group, LLC, ISBN 978-1-4200-4753-0, in particular on the page 80 and 81 of the document with further references. Such a definition is therefore incorporated by reference into this disclosure.

Modification of the set surface as a function of the dithering signal provides a modified, dithered surface. In other words, the location of points on the set surface can be changed as a function of the dithering signal. It is e.g. possible that the surface is modulated by the dithering signal. It is further possible that to each or selected points of a surface, a signal value of the dithering signal is assigned, wherein a position of a selected point is changed as a function of the signal value. It is e.g. possible that the position is shifted, in particular along a surface normal, of the selected point by the signal value or a scaled signal value.

It is also possible to modify the classification of voxels as surface voxels as a function of the dithering signal, wherein the surface voxels are voxels intersected by the input model's surface. This means that after the dithering step, other voxels are classified as surface voxels than before the dithering step.

As a result of the dithering, a spectral density of a low frequency portion of a quantization error signal will decrease, wherein a spectral density of a high frequency portion of the quantization error signal will increase. Again, the low and the high frequency portion can be divided by a threshold frequency, e.g. the aforementioned threshold frequency.

During a voxelization, voxels of the build space are classified as object voxels or non-object voxels. A subset of the object voxels can be denoted as surface voxels, wherein a surface voxel can denote a voxel which is intersected by the (set) surface.

The quantization error can denote a distance between a center of a surface voxel and the set surface along a surface normal which intersects the center. The quantization error signal can comprise the error value for each surface voxel.

In the case that no dithering step is applied, the surface can comprise the aforementioned staircaising artifacts. Such artifacts comprise, in addition to high-frequency components, a low frequency component. In other words, the quantization error signal of a non-dithered object will have or likely have such a low frequency component. Due to physical effects, e.g. the flow of printing material after application, the printing process has a low pass filter effect. While this low pass filter effect will eliminate or at least reduce the high frequency components of the quantization error, low frequency components may not or not significantly be affected. The dithering step (which shifts frequency components from the low frequency portion to the high frequency portion) will thus provide a quantization error signal with less low frequency components (which then pass the printing process-related low pass filter).

As an advantageous result, the surface dithering reduces or even removes staircasing artifacts, in particular the low frequency components, independently of their orientation and creates a smoother surface without costly and time consuming manual post-process such as sanding. Thus, the proposed method allows to create printing objects that are visually more pleasing than printing objects without surface dithering, i.e. an improved reproduction of an object to be printed.

Further, the proposed method advantageously allows the creation of printing objects which are more stable or durable due to the smoother surface because the notch effect is reduced. Further, a surface quality in three-dimensional printing is improved.

Since the proposed algorithm is a point process (neighborhood information is not required) it is also extremely fast so that the computing time is negligible within the full 3D printing pipeline—which makes it in particular suitable for mass production.

In a preferred embodiment, the dithering step further comprises

determining a voxel grid of a bounding box of the printing object or a portion thereof,

determining a voxel-specific surface distance information for each voxel of the bounding box or for selected voxels of the bounding box, wherein the voxel-specific surface distance information represents a distance between the voxel and the set surface,

modifying the surface distance information as a function of the dithering signal,

determining the modified surface depending on the modified surface distance information or classifying object voxels and non-object voxels based on the modified surface distance information.

The bounding box can comprise voxels which are occupied by the printing object, i.e. object voxels, as well as voxels which are not occupied by the printing object, i.e. non-object voxels. The bounding box can have any shape, preferably a cuboid shape. The voxel grid can be provided according to the printer resolution. This can mean that the size of a voxel is set according to the printer resolution. The bounding box comprise the complete build space or, preferably, a subspace thereof.

The voxel-specific surface distance information can be or represent a distance between a voxel center and the surface. The distance information can be provided by a numerical value.

For a surface voxel, the distance can be the distance along a surface normal which intersects the voxel center. This distance can also be referred to as sub voxel offset.

For an object voxel which is not a surface voxel, i.e. an inner voxel, the distance can be calculated as the sum of the distance of the selected voxel to its nearest surface voxel and the distance of the voxel center of the nearest surface voxel to the surface measured along a surface normal which intersects the voxel center of the nearest surface voxel.

The determination of the distance between a voxel and a surface of the printing object is e.g. outlined in the document A. Brunton et. al., “Displaced Signed Distance Fields for Additive Manufacturing,” ACM Transactions on Graphics (Proc. SIGGRAPH) Volume 40 Issue 4, August 2021, in particular in section 4 of the document. An example determination is also disclosed in the post published DE 10 2020 215 766.9. It is, however, clear to the skilled person that other distance determination methods can be applied.

The distance information can preferably be determined as a signed distance information. In this case, a negative distance can indicate the interior of the printing object, i.e. an object voxel, wherein a positive distance indicates the exterior of the printing object, i.e. a non-object voxel, or vice versa.

Modification of the surface distance information as a function of the dithering signal can e.g. be performed by changing the surface distance information, in particular the distance value, as a function of a dithering signal value. It is e.g. possible that the dithering signal value or a scaled dithering signal value is added to the surface distance information or subtracted from the surface distance information. In other words, a modified or updated set of surface distance information can be determined.

After having modified the distance information, a modified surface depending on the modified surface distance information can be determined. It is e.g. possible to determine the locations of zero crossing of a signed distance information in the set of voxels for which the modified distance information was determined, e.g. in the reference coordinate system. Such locations are located on the modified, dithered surface. In other words, the modified surface is defined by the zero crossings. If the modified surface is determined, the classification of object voxels, in particular surface voxels, can be updated. In particular, voxels intersected by the modified surface can be classified as updated surface voxels. Further, inner voxels and also non-object voxels can be classified as a function of the modified surface, e.g. by methods known to the skilled person.

Alternatively, is it possible to classify object voxels and non-object voxels based on the modified surface distance information. Such a classification can e.g. be performed by a threshold-based approach, wherein voxels with a distance smaller than or equal to a distance threshold value are classified as object voxels and voxels with a distance larger than the threshold value are classified as non-object voxels. The threshold value can depend on the voxel size, in particular the voxel size along a certain direction. Preferably, the threshold value is half of the voxel size along a surface normal which intersects the voxel center of the voxel in case of a surface voxel the voxel center of the nearest surface voxel in case of a non-surface voxel. Alternatively, the threshold value can be zero or can be determined as a function of the voxel size, in particular of the voxel size along a selected axis of the reference coordinate system or of the maximal voxel size or minimal voxel size along an axis.

In other words, a distance-based dithering is performed, wherein a voxel-specific distance to the surface information can be determined and be modified as a function of the dithering signal. Further, a dithered surface can be determined depending on the modified surface distance information. Alternatively, or in addition, classifying object voxels and non-object voxels based on the modified surface distance information can be performed.

Determining a modified, dithered surface based on the distance information advantageously allows a computationally effective and fast determination, i.e. a determination which requires low computing time and low computing power, in particular if performed with a computing device such as a microcontroller or an integrated circuit.

In a further embodiment, the dithering step further comprises

providing a three-dimensional dithering mask,

determining, for each voxel of the bounding box or for selected voxels of the bounding box, a voxel-specific distance modifying value as a function of at least one entry of the dithering mask, and modifying the voxel-specific distance information as a function of the distance modifying value.

The three-dimensional dithering mask can be the aforementioned three-dimensional matrix with values of the elements of the matrix provide signal values of the dithering signal. Each element of the dithering mask can be assigned to one voxel of the bounding box or to one of the selected voxels.

It is e.g. possible to provide a dithering mask with the same dimension as the bounding box and/or with a number of elements equal to the number of voxels of the bounding box and to assign an element i, j, k of the mask to the voxel i,j,k of the bounding box with i, j, k providing element indices. In order to provide a dithering mask with a set dimension, it is possible to first determine a reference dithering mask with smaller dimensions and then to attach multiple reference dithering masks to each other in order to provide the dithering mask with the set dimension.

In particular, the dithering mask can be a blue noise mask. An example determination of such a mask is e.g. outlined in the document Robert A. Ulichny, 1993, “Void-and-cluster method for dither array generation”, In: Human Vision, Visual Processing and Digital Display IV, Vol. 1913. International Society for Optics and Photonics, 332-343.

Modification of the voxel-specific surface distance information as a function of the distance modifying value can e.g. be performed by changing the voxel-specific surface distance information, in particular the distance value, as a function of modifying value. It is e.g. possible that the modifying value or a scaled modifying value is added to the voxel-specific surface distance information or subtracted from the voxel-specific surface distance information. In other words, a modified or updated set of voxel-specific surface distance information can be determined which can also be referred to as updated distance field.

After having modified or updated the voxel-specific distance information, a modified surface can be determined as outlined above. Alternatively, an updated classification of object voxels and non-object voxels based on the modified surface distance information can be performed as outlined above.

Determining a modified, dithered surface using a three-dimensional dithering mask allows a computationally effective and fast determination.

In a further embodiment, one mask element is assigned to each voxel of the bounding box or to the selected voxels of the bounding box, wherein the voxel-specific distance modifying value for a selected voxel is determined as the value of the mask element which is assigned to the selected voxel. Preferably, however, the voxel-specific distance modifying value for a selected voxel is determined as the value of the mask element which is assigned to the nearest surface voxel of the selected voxel. An example determination of the nearest surface voxel is e.g. described in EP 3 313 057 A1, in particular in [0122] ff. of EP 3 313 057 A1 with further references.

In particular, the nearest surface voxel can denote the voxel which is the closest surface voxel to the respective voxel of the interior voxel set. In other words, a distance according to a predetermined distance metric from the respective interior voxel to its nearest surface voxel is smaller than or equal to the distances from the respective voxel to all other surface voxels. If more than one surface voxel qualifies as nearest surface voxel, a tie-breaking algorithm can be applied in order to determine the nearest surface voxel from the set of nearest surface voxel candidates.

Such a determination of the distance modifying value allows a computationally effective and fast determination of the modified surface.

In a further embodiment, one mask element is assigned to each voxel of the bounding box or to the selected voxels of the bounding box, wherein the voxel-specific distance modifying value for a selected voxel is determined as a projection value resulting from one or multiple projection(s) of the values of the mask elements to the selected voxel (or to the mask element which is assigned to the selected voxel).

A projection value resulting from a single projection can e.g. denote a value which is determined as a function of the values of all mask elements which are intersected by a straight line which intersects the selected voxel (or the mask element assigned to the selected voxel) with a predetermined orientation, e.g. an orientation such that the line is parallel to a surface normal in the point of intersection with the surface. In this case, the projection value can e.g. be an average value of the values of all intersected mask elements. However, other relationships between the projection value and the values of the mask elements can also apply.

A (fused) projection value resulting from multiple projections can e.g. denote a value which is determined as a function of multiple projection values each resulting from a single projection, wherein the projection-specific lines are preferably parallel but intersect different points of the selected voxel. It is e.g. possible that a projection-specific line of a first single projection intersects the center of the voxel and a projection-specific line of a further single projection intersects an edge point of the selected voxel. The fused projection value can e.g. be an average value of the multiple projection values. However, other relationships between the fused projection value and the set of multiple projection values can also apply.

Such a determination of the distance modifying value advantageously improves the high-frequency characteristics used for surface dithering and therefore further improves the quality of reproduction and the durability.

In a further embodiment, the voxel-specific distance modifying value is scaled by a scaling factor which is determined as a function of a voxel size. The voxel size can be determined as the length of a line segment lying within the voxel and being a segment of the line, which intersects the voxel center and which is parallel to the surface normal as half of the size of the voxel along the surface normal which intersects the voxel center. This advantageously allows to take into account anisotropic voxel dimensions.

Alternatively or in addition, the voxel-specific distance modifying value is scaled by a scaling factor which is determined as a function of a selected printer. Such a scaling factor can e.g. be determined by printing multiple printing objects, e.g. spheres or other shapes, according to the proposed method with different scaling factors and then select the scaling factor for which the smallest quantization-induced artifacts are provided as the printer-specific scaling factor.

Such artifacts can e.g. be determined by measuring the surface profile of the printing object after printing, e.g. with known metrology systems and methods, and determining the deviation between the set surface and the printed surface as artifacts. The set surface can e.g. be determined based on the model of the printing object.

Further, the quantization-induced staircasing artifacts can be identified as deviations which occur for every orientation of the surface. In contrast to quantization-induced staircasing artifacts, printing process-induced staircaising artifacts occur only for one specific orientation of the surface, in particular the z-direction. More particular, the low frequency portion (see above) of the quantization-induced artifacts is not restricted to a single spatial direction (which is the fact for process induced artifacts). Consequently, the quantization-induced staircasing artifacts can be identified as deviations for which a low frequency portion exists in all spatial directions and not only in one specific spatial direction. The scaling factor can thus be selected such that the outlined quantization-induced staircasing artifacts are minimized.

Alternatively, quantization artifacts can be identified by visual inspection.

This advantageously allows to take into account printer-specific characteristics.

In an alternative embodiment, the dithering step further comprises

determining a voxel grid of a bounding box of the printing object or a portion thereof,

classifying voxels which are intersected by the set surface as surface voxels,

modifying the surface voxel classification as a function of the dithering signal.

It is e.g. possible to determine, at least for each surface voxel, a voxel-specific surface distance information, wherein the voxel-specific surface distance information represents a distance between the voxel and the surface of the printing object. This has been explained before. Further, the voxel-specific surface distance information can be modified as a function of the dithering signal, in particular as a function of a voxel-specific distance modifying value which is determined as a function of at least one entry of the dithering mask (see above). Then, the surface voxel classification can be updated as a function of the set of the modified voxel-specific surface distance information. Such an update can e.g. be performed by displacing the surface at each surface voxel by the modified voxel-specific surface distance information along the surface normal. Voxels which are intersected by the displaced surface are classified as updated surface voxels. The update can be performed before or after a printing material is assigned to the voxels. A printing material can be assigned to a voxel by a halftoning process or by any other suitable process.

This advantageously provides an alternative of modifying the set surface as a function of the dithering signal which also allows a fast and computationally efficient determination.

In a further embodiment, the method further comprises the step of eroding the surface of the printing object.

The erosion step is performed in order to correct for the thickening effect described before. Thus, a geometric accuracy in three-dimensional printing is improved.

The erosion step can be performed slicewise, e.g. for all slices, or for a subset of all slices, in particular z-slices, of the printing object.

Preferred embodiments of the erosion step will be outlined below. In contrast to these embodiments, erosion can be performed by applying a morphological erosion operation. Such an operation is e.g. described in the textbook Shih, Frank Y., Image processing and mathematical morphology: Fundamentals and Applications, CRC press, 2009, in particular on pages 17 to 20 of the textbook.

It is also possible to perform a distance-based erosion. In this case, a voxel-specific distance to the surface information can be determined, at least for each surface voxel or for all voxels of the selected z-slice or of the (three-dimensional) voxel grid. Then, the voxel-specific surface distance information can be modified as a function of a, in particular predetermined, more particular constant, erosion value. Further, an eroded surface can be determined depending on the modified surface distance information. Alternatively, or in addition, classifying object voxels and non-object voxels based on the modified surface distance information can be performed.

The voxel-specific surface distance information can be or represent a distance between a voxel center and the surface in the two-dimensional z-slice or in the three-dimensional space. The distance information can be provided by a numerical value.

Modification of the voxel-specific surface distance information as a function of the erosion value can e.g. be performed by changing the surface distance information, in particular the distance value, as a function of the erosion value. It is e.g. possible that the (positive) erosion value is subtracted from the surface distance information. In other words, a modified or updated set of voxel-specific surface distance information can be determined.

After having modified the distance information, an eroded surface depending on the modified surface distance information can be determined. It is e.g. possible to determine the locations of zero crossing of a signed distance information in the set of voxels for which the modified distance information was determined, e.g. in the reference coordinate system or the two-dimensional coordinate system of the z-slice. Such locations are located on the eroded surface. In other words, the eroded surface is defined by the zero crossings. If the eroded surface is determined, the classification of object voxels, in particular surface voxels, can also be updated. In particular, voxels intersected by the eroded surface can be classified as updated surface voxels. Further, inner voxels and also non-object voxels can be classified as a function of the eroded surface, e.g. by methods known to the skilled person.

Alternatively, is it possible to classify object voxels and non-object voxels based on the eroded surface distance information. Such a classification can e.g. be performed by a threshold-based approach, wherein voxels with a distance smaller than or equal to a distance threshold value are classified as object voxels and voxels with a distance larger than the threshold value are classified as non-object voxels. As explained before, the threshold value can depend on the voxel size.

The erosion step can preferably be performed before the dithering step. In this case, the eroded surface can provide the aforementioned set surface for the dithering step, i.e. the surface which is modified as a function of the dithering signal. It is, however, also possible that the erosion step is performed after the dithering step. In this case, the dithered surface can provide the set surface for the erosion step, i.e. the surface which is modified as a function of the erosion signal.

The thickening correction by performing the erosion step advantageously improves the geometric accuracy of printing objects. Particularly for thin structures the printing process-based thickening can be significant, e.g. up to 20% of the original thickness for a 2 mm cylinder. High geometric accuracy is important for interlocking printing objects but it also improves the visual appearance of thin printing objects.

The erosion step according to one of the embodiments described herein can provide an independent invention and does not necessarily depend on the dithering step. Thus, a method for three-dimensional printing is described which comprises the steps of eroding a surface of the printing object (erosion step), printing the printing object with the eroded surface (printing step).

In a further embodiment, the erosion step comprises

determining a surface of the printing object in a selected z-slice,

determining a reference axis as a medial axis of the surface or a subset thereof,

determining, for each or selected points of the surface, a distance to the reference axis and an erosion value as a function of the distance,

modifying the surface depending on the erosion value.

The erosion step can be performed for all or selected z-slices of the printing object, i.e. repeatedly.

A z-slice denotes a layer of the voxel grid comprising the printing object, wherein the voxel of the layer all have the same z-coordinate. In other words, the z-slice is a two-dimensional cross section through the voxel grid at a selected z-coordinate.

The medial axis denotes a set of object points which have more than one closest point on the surface. In this case, the medial axis denotes a set of object points in the two-dimensional z-slice which have more than one closest point on the two-dimensional surface in the z-slice.

The distance to the reference axis is determined as a distance in the z-slice, e.g. a dimension in a two-dimensional space. The distance can be a numerical value.

The erosion value can be determined by using a functional relationship or a predetermined assignment between the distance and the erosion value.

Modification of the surface depending on the erosion value can e.g. be done by shifting the selected surface point by the amount of the erosion value, in particular inwards, e.g. along the line with the shortest distance connecting the reference axis and the selected point or along the surface normal in the selected point.

Using the distance to the reference axis being the medial axis or a subset thereof advantageously allows to adapt the erosion to thin parts of the printing object. In particular if the erosion value is chosen to be zero if the distance to the reference axis is smaller than a predetermined distance threshold value, an undesired complete erosion can be prevented. This, in turn, allows to further improve a reproduction quality.

In a further embodiment, the erosion step comprises

determining, at least for each surface voxel of the selected z-slice, a voxel-specific distance to the reference axis and an erosion value as a function of the distance,

modifying the voxel-specific surface distance information as a function of the erosion value,

determining the modified surface depending on the modified surface distance information or classifying object voxels and non-object voxels based on the modified surface distance information.

The erosion value which is determined as a function of the voxel-specific distance of a selected voxel can be assigned to the voxel. It is also possible that an erosion value is determined for each voxel of the voxel grid in the selected z-slice. In particular, the erosion value assigned to the nearest surface voxel can be assigned to a selected (object) voxel of the z-slice, in particular to a selected inner voxel.

The voxel-specific surface distance information can be or represent a distance between a voxel center and the surface in the two-dimensional z-slice. The distance information can be provided by a numerical value.

Modification of the voxel-specific surface distance information as a function of the erosion value can e.g. be performed by changing the surface distance information, in particular the distance value, as a function of the erosion value. It is e.g. possible that the (positive) erosion value is subtracted from the surface distance information. In other words, a modified or updated set of voxel-specific surface distance information can be determined.

After having modified the distance information, an eroded surface depending on the modified surface distance information can be determined. It is e.g. possible to determine the locations of zero crossing of a signed distance information in the set of voxels for which the modified distance information was determined, e.g. in the reference coordinate system or the two-dimensional coordinate system of the z-slice. Such locations are located on the eroded surface. In other words, the eroded surface is defined by the zero crossings. If the eroded surface is determined, the classification of object voxels, in particular surface voxels, can be updated. In particular, voxels intersected by the eroded surface can be classified as updated surface voxels. Further, inner voxels and also non-object voxels can be classified as a function of the eroded surface, e.g. by methods known to the skilled person.

Alternatively, it is possible to classify object voxels and non-object voxels based on the eroded surface distance information. Such a classification can e.g. be performed by a threshold-based approach, wherein voxels with a distance smaller than or equal to a distance threshold value are classified as object voxels and voxels with a distance larger than the threshold value are classified as non-object voxels. As explained before, the threshold value can depend on the voxel size.

Determining an eroded surface based on the distance information advantageously allows a computationally effective and fast determination, i.e. a determination which requires low computing time and low computing power.

In a further embodiment, the voxel-specific distance to the reference axis is determined as a function of the distance between the voxel center and the reference axis and the distance between the voxel center and the surface along the surface normal, in particular a surface normal which intersects the voxel center. This advantageously allows a computationally fast and effective determination of the voxel-specific distance.

In a further embodiment, the erosion value and the distance to the reference axis are positively correlated for at least one interval of distance values. This can mean that for at least one interval of distance values, the erosion value increases with increasing distance values.

A positive correlation can be provided by a linear relationship, a step-shaped relationship, a ramp-shaped relationship. It, is however, clear to the skilled person that also other relationships can apply.

Using a positive correlation advantageously improves the adaption of the erosion to thin parts of the printing object. This, in turn, allows to further improve a reproduction quality.

In a further embodiment, the erosion value is set to a minimal value if the distance to the reference axis is smaller than a predetermined threshold value and/or that the erosion value is set to a maximal value if the distance to the reference axis is greater than the predetermined threshold value or a further predetermined threshold value.

Using threshold values advantageously further improves the adaption of the erosion to thin parts of the printing object. This, in turn, allows to further improve a reproduction quality.

It is further possible that the erosion value can additionally be determined as a function of one or more tonal value(s) or as a function of one more printing material(s) assigned to the selected surface voxel or as a function of a surface orientation in the selected surface voxel. A tonal value can e.g. be c-, m-, y-, k-value within a CMYK-vector defining a set printing material ratio of a selected voxel, wherein the ratio can e.g. be used for a subsequent halftoning process by which one or more printing material(s) is/are assigned to the selected voxel. It is e.g. possible that a predetermined assignment between different tonal values and erosion value changes is provided, wherein the erosion value is changed as a function of the erosion value change assigned to the erosion value, e.g. by adding the erosion value change to or subtracting it from the erosion value.

The erosion value can additionally be determined as a function of the surface orientation, in particular the surface normal, or as a function of a surface facing characteristic, i.e. whether the surface is facing upwards or downwards during printing. It is e.g. possible that a predetermined assignment between different surface orientations or surface facing characteristic and erosion value changes is provided, wherein the erosion value is changed as a function of the erosion value change assigned to the erosion value, e.g. by adding the erosion value change to or subtracting it from the erosion value.

This advantageously allows to adaptively correct tonal or surface-orientation dependent thickening effects by the printing process and thus to improve the geometric accuracy of the final print.

In general, the proposed method advantageously allows the production or prototyping of functional parts for which smooth surfaces and geometric accuracy is crucial, e.g. medical products such as eye prosthetics or dental prosthetics as well as products used in entertainment such as movies or gaming.

Further proposed is a computer program product with a computer program, wherein the computer program comprises software for the execution of one, multiple or all steps of the method for three-dimensional printing according to one of the embodiments described in this disclosure if the computer program is executed by or in a computer or an automation system.

Further described is a program which, when running on a computer or in an automation system, causes the computer or the automation system to perform one or more or all steps of the method for three-dimensional printing according to one of the embodiments described in this disclosure and/or to a program storage medium on which the program is stored (in particular in a non-transitory form) and/or to a computer comprising the program storage medium and/or to a (physical, for example electrical, for example technically generated) signal wave, for example a digital signal wave, carrying information which represents the program, for example the aforementioned program, which for example comprises code that is adapted to perform any or all of the method steps described herein.

This means that the method in accordance with the invention is for example a computer implemented method. For example, all the steps or merely some of the steps (i.e. less than the total number of steps) of the method in accordance with the invention can be executed by a computer. An embodiment of the computer implemented method is a use of the computer for performing a data processing method. The computer for example comprises at least one microcontroller or processor and for example at least one memory in order to (technically) process the data, for example electronically and/or optically. The processor being for example made of a substance or composition which is a semiconductor, for example at least partly n- and/or p-doped semiconductor, for example at least one of II-, III-, IV-, V-, VI-semiconductor material, for example (doped) silicon and/or gallium arsenide. The calculating steps described are for example performed by a computer. Determining steps or calculating steps are for example steps of determining data within the framework of the technical method, for example within the framework of a program. A computer is for example any kind of data processing device, for example electronic data processing device. A computer can be a device which is generally thought of as such, for example desktop PCs, notebooks, netbooks, etc., but can also be any programmable apparatus, such as for example a mobile phone or an embedded processor. A computer can for example comprise a system (network) of “sub-computers”, wherein each sub-computer represents a computer in its own right.

Steps executed or performed by a computer or an automation system can in particular be the dithering step and/or the erosion step and/or a control step by which the printing process is controlled.

The computer program product advantageously allows to perform a method for three-dimensional printing according to one of the embodiments described in this disclosure for which technical advantages have been outlined before.

Further proposed is a 3D printing device, wherein the printing device comprises at least one means for printing a printing material and at least one control unit. The 3D printing device is configured to perform a method for three-dimensional printing according to one of the embodiments described in this disclosure. The control unit, which can be provided by at least one microcontroller or at least one integrated circuit, can be configured to perform the dithering step, the erosion step and/or a control step. The control unit can have an interface for receiving input data generated in a modelling step. The 3D printing device advantageously allows to perform a method for three-dimensional printing according to one of the embodiments described in this disclosure for which technical advantages have been outlined before.

Further described is a printing object, wherein the printing object is obtained or obtainable or directly obtained by a method for three-dimensional joint color and translucency printing according to one of the embodiments disclosed in this disclosure. The printing objects obtained by the proposed method with a dithering step possess a smoother surface without or with reduced quantization-error induced staircasing artifacts in comparison to printing objects obtained without the proposed dithering step. As outlined above, such quantization-induced artifacts can be determined by measuring the surface of the printing object, determining the deviation between the printed surface and the set surface and identifying the quantization-induced artifacts as deviations with a low frequency portion in all spatial directions.

It is possible that the computational time required to generate control data for the printing process with the dithering step (i.e. according to the invention) is equal to or is not more than 10% higher than the computational time required to generate control data for the printing process without the proposed dithering step for the same input data and using the same computational unit(s), i.e. under the same underlying conditions.

The printing objects obtained by the proposed method with an erosion step possess an improved geometric accuracy without or with reduced thickened structures in comparison to printing objects obtained without the proposed erosion step. The thickening effect can e.g. be measured by printing cylinders with a longitudinal axis being orthogonal to the surface of the z-slices of the printing object and determining the deviation between the diameter of the printed cylinder and the set diameter (which can e.g. be determined based on the digital model of the cylinder). The diameter of the printed cylinder can be determined by a caliper or by other metrology devices for measurement.

Also described is a printing object for which the model data is chosen such that a distinct quantization error is present at print resolution and wherein these quantization errors are removed or strongly reduced, in particular regardless of their orientation, in the printing object after the printing step.

### BRIEF DESCRIPTION OF THE DRAWINGS

The present disclosure will become more fully understood from the detailed description and the accompanying drawings.

FIG. 1 is a schematic block diagram of the 3D printer.

FIG. 2 is a schematic flow diagram of a printing method according to the invention.

FIG. 3 is a schematic flow diagram of a printing method according to another embodiment of the invention.

FIG. 4 is a schematic representation of a voxel grid without dithering.

FIG. 5 is a schematic representation of material coverage without dithering.

FIG. 6 is a schematic representation of a voxel grid with dithering.

FIG. 7 is a schematic representation of material coverage with dithering.

FIG. 8 is a schematic representation of a z-slice.

FIG. 9 is a schematic representation of an erosion function.

In the drawings, reference numbers may be reused to identify similar and/or identical elements.

### DETAILED DESCRIPTION

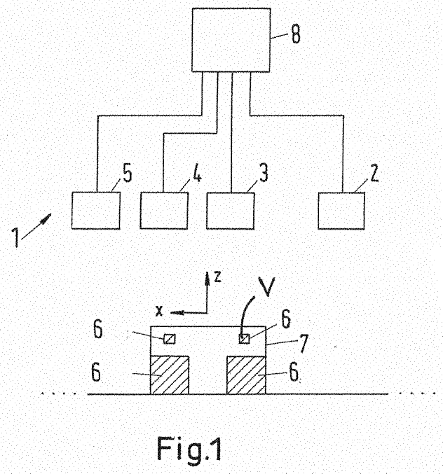

FIG. 1 shows a schematic representation of a three-dimensional printing device 1. The printing device 1 comprises a print heads 2, 3, 4, 5. The print heads 2, 3, 4, 5 can be used for printing materials with different colors and/or translucencies as well as support material 6. A printing device 1, however, is not required to have multiple print heads 2, 3, 4, 5 as only one print head is sufficient for carrying out the method according to the invention. Further shown is a printing object 7 which is T-shaped and which consists of printing material.

Indicated is a printing space or build space reference coordinate system with a longitudinal axis which is also referred to as x-axis. An arrowhead indicates an x-direction. Further indicated is a vertical axis which is also referred to as z-axis, wherein an arrowhead indicates a vertical direction or z-direction. The vertical axis is pointing upwards. A lateral axis which is also referred to as y-axis can be oriented perpendicular the x-axis and the z-axis, wherein the axes can provide a right-hand Cartesian coordinate system.

Further shown is that the printing device 1 comprises a control unit 8 for controlling a movement and/or an operation of the print heads 2, 3, 4, 5. The control unit 8 can comprise or be provided by at least one microcontroller or by at least one integrated circuit.

In particular, the print heads 2, 3, 4, 5 can be controlled such that the printing materials are arranged in voxels V, wherein for the sake of illustration, only one voxel V is denoted by a reference sign.

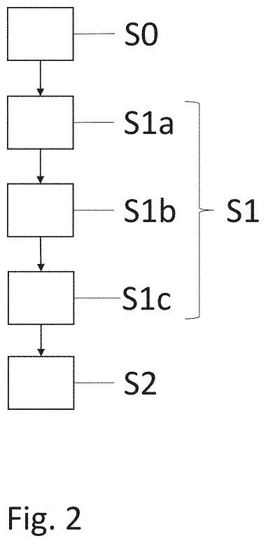

FIG. 2 shows a schematic flow diagram of a method for 3D printing according to the invention. In a modeling step S0 which is not necessarily part of the proposed method, input data is generated which encodes reproduction information on the printing object 7, e.g. shape information, color information and/or translucency information.

The method comprises a dithering step S1. The dithering step S1 is performed to determine a model with a dithered, modified surface in comparison to the model provided by the input data. In a first substep S1a of the dithering step S1, a set surface 9 of the printing object 7 is determined, in particular a set surface of the model provided by the input data. In a second substep S1b, a spatially high-frequent dithering signal is provided. In a third substep S1c, the set surface 9 is modified as a function of the dithering signal and a modified, dithered surface is determined.

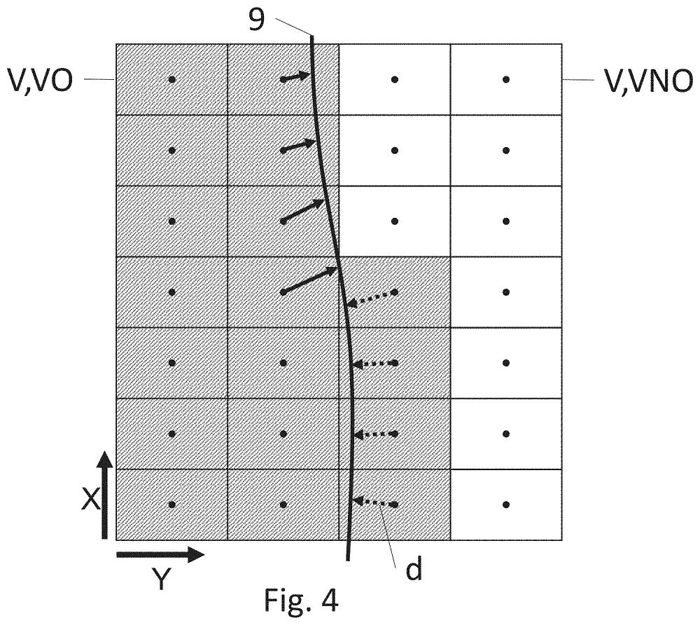

Modification of the set surface can e.g. be performed by determining a voxel grid of a bounding box of the printing object 7 which comprises voxels V and to determine a voxel-specific surface distance information (see e.g. FIG. 4) for each voxel of the bounding box which represents the distance d between the selected voxel V and the set surface 9. Then, the surface distance information (which can e.g. be the distance d itself) is modified as a function of the dithering signal. In particular, the distance d can be determined as a signed distance and a dithering signal value which can take positive or negative values is added to the distance d. In other words, a distance d to the surface 9 is changed for each selected voxel V.

Then, the dithered surface can be determined depending on the modified surface distance information, e.g. as a section of zero crossings defined by the modified surface distance information. The section can e.g. be determined by interpolating or extrapolating the modified surface distance information.

Alternatively, a classification of voxels V of the bounding box into object voxels VO and non-object voxels VNO can be changed or updated based on the modified distance information. It is e.g. possible to perform a threshold-based approach, wherein voxels V with a distance d smaller than or equal to a distance threshold value are classified as object voxels VO and voxels V with a distance larger than the threshold value are classified as non-object voxels VNO.

The dithering signal is preferably provided by a three-dimensional dithering matrix wherein the entry values of the matrix provide a spatially high-frequent signal along each direction through the matrix. In this case, the dithering matrix can have the same voxel size as the bounding box and each element of the dithering matrix V is assigned to one voxel V of the bounding box. In particular, a matrix element with an ordinal number vector i, j, k can be assigned to the voxel V with the same ordinal number vector, wherein i can denote an ordinal number along the x-axis, j can denote an ordinal number along the y-axis, and k can denote an ordinal number along the z-axis. In this case, the value of the matrix element can provide the dithering signal value for the distance d of a selected voxel V. Preferably, however, the value of the matrix element which is assigned to the closest surface voxel of a selected voxel V can provide the dithering signal value for the distance d of the selected voxel V.

In a printing step S2, the printing object 7 is printed with the dithered surface. In other words, the model data which is modified by the dithering step S1 provides the input data for the printing step S2.

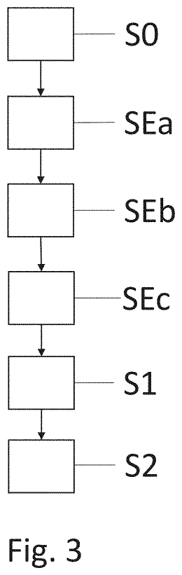

FIG. 3 shows a schematic flow diagram of a method for 3D printing according to another embodiment of the invention. In addition to the steps S0, S1, S2 of the method according to the embodiment shown in FIG. 1, the method further comprises an erosion step SE.

The erosion step SE is performed to determine a model with an eroded, modified surface in comparison to the model provided by the input data. The erosion step SE is performed before the dithering step S1. This means that the eroded surface provides the set surface for the dithering step S1, i.e. the surface which is modified as a function of the dithering signal.

In a first substep SEa of the erosion step SE, a set surface 9 of the printing object 7 is determined, in particular a set surface of the model provided by the input data. In a second substep SEb, an erosion value is provided. In a third substep SEc, the set surface 9 is modified as a function of the erosion value and a modified, eroded surface is determined.

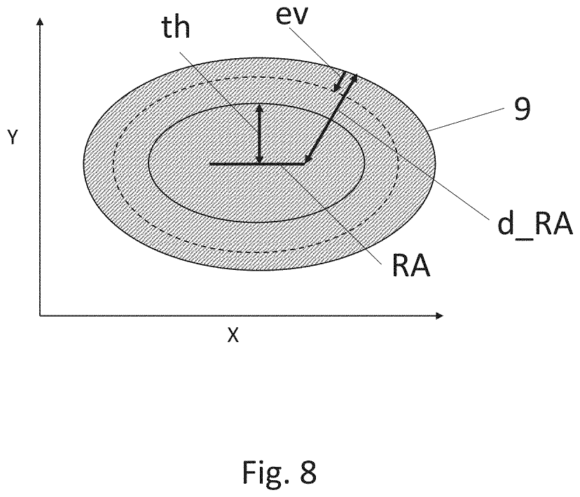

Modification of the set surface 9 can e.g. be performed by determining a voxel grid of a bounding box of the printing object 7 which comprises voxels V and to determine a voxel-specific surface distance information (see e.g. FIG. 4) for each voxel of the bounding box which represents the distance d between the selected voxel V and the set surface 9. This distance information can e.g. be determined in a selected z-slice 11 (see e.g. FIG. 8) or for each voxel V in the three-dimensional bounding box.

Then, the surface distance information (which can e.g. be the distance d itself) is modified as a function of the erosion value. In particular, the distance d can be determined as a signed distance and an erosion value which can take negative values is added to the distance d. In other words, a distance d to the surface is changed for each selected voxel V.

Then, as outlined before with respect to the dithering step S1, the eroded surface can be determined depending on the modified surface distance information, e.g. as a section of zero crossings defined by the modified surface distance information, or a classification of voxels V of the bounding box into object voxels VO and non-object voxels VNO can be changed or updated based on the modified distance information.

Preferably, the erosion value is determined for a selected voxel V, in particular for each surface voxel of a selected z-slice 11, as a function of a voxel-specific distance d_RA to a reference axis RA, wherein the reference axis RA is a medial axis which denotes a set of object points which have more than one closest point on the surface 9. In particular, the medial axis denotes a set of object points in the two-dimensional z-slice 11 which have more than one closest point on the two-dimensional surface 8 in the z-slice 11.

The voxel-specific distance d_RA to the reference axis RA for a surface voxel is in particular determined as a function of the distance between the voxel center and the reference axis RA and the distance between the voxel center and the surface 8 along the surface normal.

The erosion value and the distance d_RA to the reference axis RA can be functionally related such that they are positively correlated for at least one interval of distance values.

FIG. 4 shows schematic representation of a voxel grid without dithering. Shown are voxels V in a z-slice 11, wherein—for the sake of illustration—only one voxel V is denoted by a reference numeral. Crosshatched voxels V represent voxels which are classified as object voxels VO, i.e. voxels V in which printing material will be arranged in the printing process. Non-crosshatched voxels V represent voxels V which are classified as non-object voxels VNO, i.e. voxels V in which no printing material will be arranged in the printing process.

Further shown is a set surface 9 of the printing object 7 and a set course of the surface 9 in the reference coordinate system. Voxels V which are intersected by the surface course are classified as surface voxels.

For all surface voxels, a distance d between the respective voxel V and the set surface 9 is shown. The distance d is a signed distance, wherein a solid line represents a negative distance value and a dotted line a positive value (or vice versa).

It can be seen that due to the voxel resolution and the course of the set surface 9, the course of the voxels V classified as surface voxels features a step, i.e. has a step-like course. This step provides a quantization error and generates a staircasing artifact in the printing object 7.

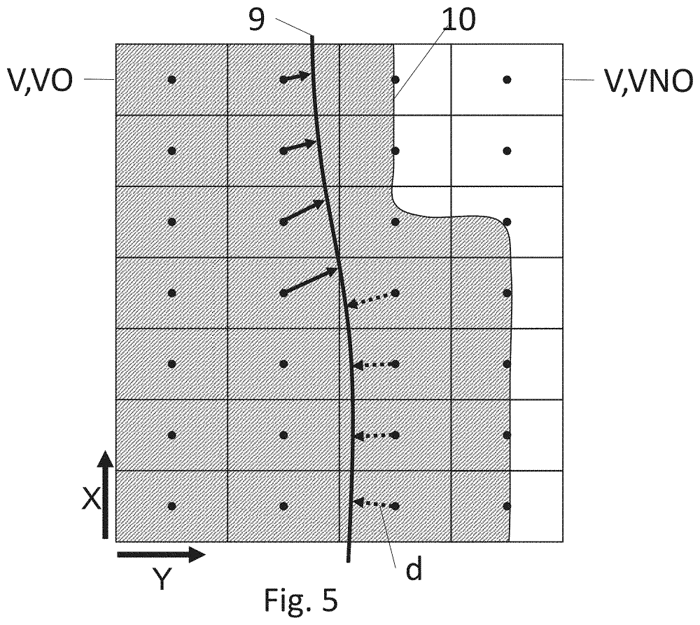

FIG. 5 shows a schematic representation of printing material coverage if the printing object 7 is printed according to the voxel classification shown in FIG. 4. A crosshatched area represents the printing object 7, wherein a non-crosshatched area represents an area outside the printing object 7.

In comparison to the voxels shown in FIG. 4, the arrangement of printing material in a selected voxel V will lead to the effect that excessive printing material will also be arranged in neighboring voxels V, in particular in voxels V which have been classified as non-object voxels VNO.

Indicated is a printed surface 10 of the printing object 7, i.e. a surface of the printing object 7 which is provided by the printing process. It can be seen the surface course of the printed surface 10 also features a step, i.e. has a step-like course. Due to this step like course, in particular due to a spatial course along the step in a direction parallel to the z-axis, i.e. perpendicular to the drawing plane, the printed surface 10 will feature low spatial frequencies. Also, the step like course parallel to the y-axis shown in FIG. 5 will provide a spectrum with a low spatial frequency portion as a step is typically composed of low frequency components.

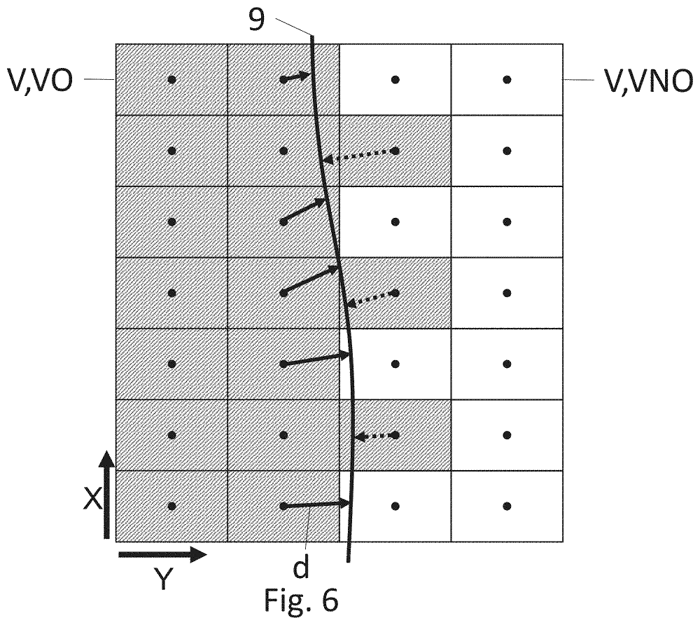

FIG. 6 shows schematic representation of a voxel grid after a dithering step S1 has been performed. Shown is a set surface 9, i.e. an un-dithered surface, of the printing object 7 and a set course of the surface 9 in the reference coordinate system. Further shown is a distance d between the respective voxel V and the set surface 9 after a dithering step S1 has been performed. Voxels V which are intersected by the dithered surface (not shown in FIG. 6) are classified as surface voxels. It can be seen that due to the voxel resolution and the course of the set surface 9, the surface is dithered.

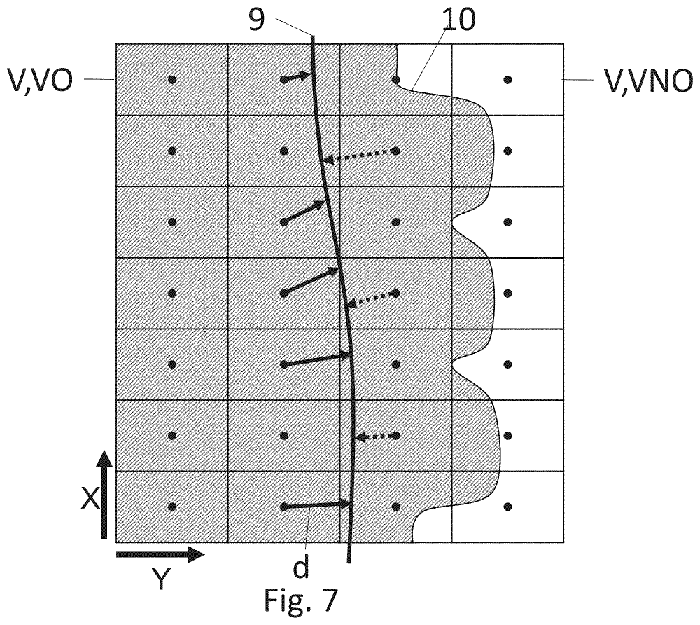

FIG. 7 shows a schematic representation of printing material coverage if the printing object 7 is printed according to the voxel classification shown in FIG. 6. Also indicated is a printed surface 10 of the printing object 7 and a surface course of the printing object 7 which is provided by the printing process. It can be seen that the surface course of the printed surface 10 does not feature a step like the embodiment shown in FIG. 5 but has a corrugated course. In particular, a low frequency portion of the spectrum of spatial frequencies of the surface course shown in FIG. 7 will be smaller than a low frequency portion of the spectrum of spatial frequencies of the surface course shown in FIG. 5.

FIG. 8 shows a schematic representation of a z-slice 11 of a printing object 7. Indicated are a longitudinal and a lateral axis x, y of the reference coordinate system and a set surface 9 of the printing object 7.

Further shown is a reference axis RA of the two-dimensional cross section of the printing object 7 in the plane defined by the selected z-slice 11, a distance threshold value th, an erosion value ev and a distance d_RA between the reference axis 12 and the set surface 9.

The reference axis RA is a medial axis of the two-dimensional representation of the printing object 7 in the selected z-slice 11. The distance d_RA denotes a minimal distance for a selected point on the set surface 9 to the reference axis RA. The erosion value ev is determined as an output value of an erosion function which maps an input value to the output value. To determine the erosion value ev for a selected point on the set surface 9, the distance d_RA is determined and mapped to the erosion value ev. The functional relationship can provide a positive correlation between the erosion value and the distance d_RA for at least one interval of distance values. In particular, the functional relationship can feature a ramped-shaped course or a step-like course for at least one interval of distance values.

In a voxel based representation of the z-slice 11, the input value for each surface voxel can be determined as the sum of a distance of a voxel center to the reference axis RA and the distance of the voxel center to the set surface 9 along a surface normal which intersects the voxel center. Surface voxels in the selected z-slice 11 of a voxel-based representation of the printing object 7 are voxels which are intersected by the set surface 9.

As outlined before, the erosion value ev is then used to modify the set surface 9 in order to provide an eroded surface.

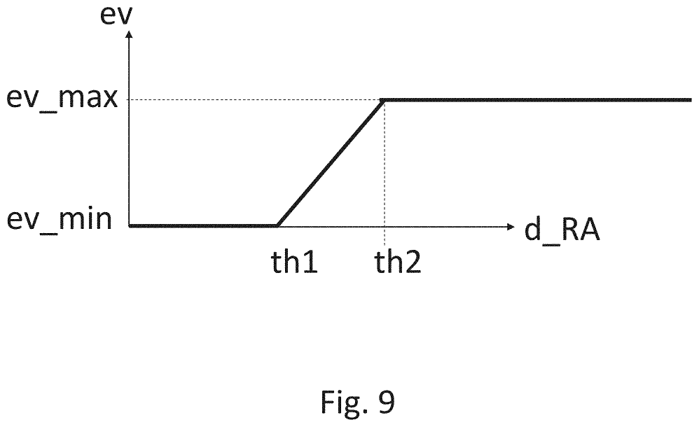

FIG. 9 shows a schematic representation of an erosion function. Indicated is an input value which is a value of distance d_RA of a point on the set surface 9 to the reference axis 12. The output value is the erosion value ev. Further indicated are distance threshold values th1, th2. For distance values d_RA which are smaller than a first threshold value th1, the erosion value ev is determined as a constant minimal erosion value ev min which can e.g. be zero. For distance values d_RA which are larger than a second threshold value th2, the erosion value ev is determined as a constant maximal erosion value ev max. The first distance threshold value th1 is smaller than the second distance threshold value th2. For distance values d_RA between the first and the second distance threshold value th1, th2, the erosion value ev increases with an increasing distance value, e.g. in a linear manner. It is, however, also possible that an alternative relationship between the distance value d and the erosion value ev is applied, e.g. a relationship by which the erosion value ev is positively correlated with the distance value d for at least an interval of distance values.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc). The phrase at least one of A, B, and C should be construed to mean a logical (A OR B OR C), using a non-exclusive logical OR, and should not be construed to mean “at least one of A, at least one of B, and at least one of C.”

1. A method for three-dimensional printing comprising:
dithering a set surface of a printing object; and
printing the printing object with the dithered surface,
wherein the dithering includes:
determining the set surface of the printing object,
providing a spatially high-frequent dithering signal, and
modifying the set surface as a function of the dithering signal.

2. The method of claim 1 wherein the dithering further includes:
determining a voxel grid of a bounding box of the printing object or a portion thereof;
determining a voxel-specific surface distance information for each voxel of the bounding box or for selected voxels of the bounding box, wherein the voxel-specific surface distance information represents a distance between the voxel and the set surface;
modifying the surface distance information as a function of the dithering signal; and
determining the modified surface depending on the modified surface distance information or classifying object voxels and non-object voxels based on the modified surface distance information.

3. The method of claim 2 wherein the dithering includes:
providing a three-dimensional dithering mask; and
for each voxel of the bounding box or for selected voxels of the bounding box:
determining, a voxel-specific distance modifying value as a function of at least one entry of the dithering mask, and
modifying the voxel-specific distance information as a function of the distance modifying value.

4. The method of claim 3 wherein:
one mask element is assigned to each voxel of the bounding box or to the selected voxels of the bounding box; and
the voxel-specific distance modifying value for a selected voxel is determined as the value of the mask element that is assigned to the selected voxel or as the value of the mask element that is assigned to the nearest surface voxel of the selected voxel.

5. The method of claim 3 wherein:
one mask element is assigned to each voxel of the bounding box or to the selected voxels of the bounding box; and
the voxel-specific distance modifying value for a selected voxel is determined as a projection value resulting from at least one projection of the values of the mask elements to the selected voxel.

6. The method of claim 3 further comprising scaling the voxel-specific distance modifying value by a scaling factor that is determined based on at least one of:
a voxel size; and
a selected printer.

7. The method of claim 1 wherein the dithering includes:
determining a voxel grid of a bounding box of the printing object or a portion thereof;
classifying voxels which are intersected by the set surface as surface voxels; and
modifying the surface voxel classification as a function of the dithering signal.

8. The method of claim 1 further comprising eroding the surface of the printing object.

9. The method of claim 8 wherein the eroding includes:
determining a set surface of the printing object in a selected z-slice;
determining a reference axis as a medial axis of the surface or a subset thereof;
determining, for each or selected points of the surface, a distance to the reference axis and an erosion value as a function of the distance; and
modifying the surface depending on the erosion value.

10. The method of claim 9 wherein the eroding includes:
determining, at least for each surface voxel of the selected z-slice, a voxel-specific distance to the reference axis and an erosion value as a function of the distance;
modifying the voxel-specific surface distance information as a function of the erosion value; and
determining the modified surface depending on the modified surface distance information or classifying object voxels and non-object voxels based on the modified surface distance information.

11. The method of claim 10 wherein the voxel-specific distance to the reference axis is determined as a function of the distance between a center of the voxel and the reference axis and the distance between the voxel center and the surface along the surface normal.

12. The method of claim 9 wherein the erosion value and the distance to the reference axis are positively correlated for at least one interval of distance values.

13. The method of claim 9 wherein the erosion value is set to a minimal value in response to the distance to the reference axis being smaller than a predetermined threshold value.

14. The method of claim 13 wherein the erosion value is set to a maximal value in response to the distance to the reference axis being greater than the predetermined threshold value.

15. The method of claim 13 wherein the erosion value is set to a maximal value in response to the distance to the reference axis being greater than a further predetermined threshold value.

16. The method of claim 9 wherein the erosion value is set to a maximal value in response to the distance to the reference axis being greater than a predetermined threshold value.

17. A non-transitory computer-readable medium comprising instructions that implement the method of claim 1.

18. A 3D printing device comprising:
a printing device; and
a control unit configured to control the printing device using the method of claim 1.
